(19) United States
(12) Patent Application Publication
(10) Pub. No.: US 2005/0052565 A1
(43) Pub. Date: Mar. 10, 2005

(54) Solid-state imaging device

(76) Inventor: Junichi Hamada, Kagoshima (JP)

Correspondence Address: ROBERT J. DEPKE LEWIS T. STEADMAN;HOLLAND & KNIGHT LLC, 131 SOUTH DEARBORN, 30TH FLOOR, CHICAGO, IL, 60603, US

(21) Appl. No.: 09/850,752

(22) Filed: May 8, 2001

(30) Foreign Application Priority Data
May 10, 2000 (JP) P2000-137522

(51) Int. Cl. H04N 5/235

(52) U.S. Cl. 348/362

(57) ABSTRACT

To provide a solid-state imaging device capable of outputting a captured image with a high quality through high-speed transferring and discharging of smears during the exposure operation. Within an exposure period T1 of photosensors a11-amn, vertical driving signals V1-V3 are inputted from a control driver circuit 13 into a solid-state image sensor 10 within the b-region, and smears within vertical registers 2a-2n are transferred to a horizontal register 3 at a high speed and discharged by horizontal driving signals H1 and H2, and the exposure of the solid-state image sensor 10 is terminated within the a-region, and the light incident on the solid-state image sensor 10 is blocked by a mechanical shutter 12 in response to a shutter driving signal Fc from the control driving circuit 13, and the image signal charges within the photosensors a11-anm are read out during an all-pixel-output period T2, The charges that have been photoelectric-converted in areas other than the photosensors a11-anm are leaked into the vertical registers 2a-2n, and smears that cause the formation of vertical bright streaks on an image plane are eliminated within the exposure period, thereby enabling to obtain a clear and high-quality image (see FIGS. 1 and 2).

The present invention relates to a solid-state imaging device, especially to a solid-state imaging device provided with a function to perform smear elimination during image capturing operation.

In a solid-state imaging device comprising a 2D image sensor, which is used as a digital still camera, vertical registers for transferring read-out charges in the vertical direction are respectively disposed at the corresponding locations adjacent to the respective columns (arranged in the vertical direction) of a matrix of light-receiving elements performing photoelectric conversion as the light-receiving portion, and to these plurality of vertical registers, a horizontal register for transferring the charges in the horizontal direction is connected, so that charges read out by the vertical registers from the light-receiving portion and transferred to the horizontal register are transferred by the horizontal register by every one field and read out as a received light signal.

In a solid-state imaging device such as the one previously described, it is known that, if the incident light entered into the light-receiving elements of the light-receiving portion leaks into any areas other than the imaging positions, and is photoelectric-converted and then introduced into the vertical registers, then smears forming bright light patterns of trailing vertical streaks, may occur over a plane of the captured image.

Since the bright light patterns of vertical streaks are added on to the image plane when smears occur, the viewability of the captured image, thus, the quality of the captured image would be degraded.

The present invention was invented in consideration with the present conditions with regard to the generation of smears, which cause the degradation in the quality of a captured image, in the above-mentioned solid-state imaging device, and an object thereof is to provide a solid-state imaging device capable of outputting captured images with a high quality by transferring and discharging smears at a high speed during exposure operation of a solid-state imaging device.

In order to achieve the above object, the invention as claimed in claim 1 is a solid-state imaging device having a light-receiving portion, a vertical register and a horizontal register wherein an input light signal received by the light-receiving section during an exposure period is photoelectric-converted in the light-receiving portion, and obtained charges are read into the vertical register, transferred from the vertical register to the horizontal register, and then detected as a received light signal, said solid-state imaging device comprising a mechanical shutter for performing operations of opening and closing the reception of the input light signal by the light-receiving portion, smear discharging means for sweeping out and discharging smears in the vertical register via the horizontal registers by transferring the smears at a high speed within the exposure period during which the mechanical shutter is performing the opening operation, light detection means for detecting the received light signal by transferring, through the vertical register and the horizontal register, the charges obtained through the photoelectric conversion performed in the light-receiving portion and detecting them, and detection control means for controlling the light detection in a manner that the light detection means is driven to detect the received light signal after smears are discharged by the smear discharging means, and the mechanical shutter is driven to perform the closing operation after the detection is completed.

According to this approach, an input light signal received by a light-receiving portion during an exposure period is photoelectric-converted, and so obtained charges are read into vertical registers and transferred from the vertical registers to a horizontal register, and then detected as a received light signal, and the control provided by a detection control means allows the smears within the vertical registers to be transferred at a high speed by smear discharging means within the exposure period during which a mechanical shutter is performing the opening operation to allow the reception of the input light signal by the light-receiving portion, and after smears are swept out and discharged via the horizontal registers, the charges obtained through the photoelectric conversion in the light-receiving portion are transferred through the vertical registers and the horizontal register and detected as a received light signal by the light detection means, and thereafter, the mechanical shutter is driven to perform closing operation, so that the charges obtained through the photoelectric conversion in areas other than the light-received portion are leaked into the vertical registers and the smears causing the formation of vertical bright streaks over the image plane may be eliminated within the exposure period, thereby providing a clear and high-quality image.

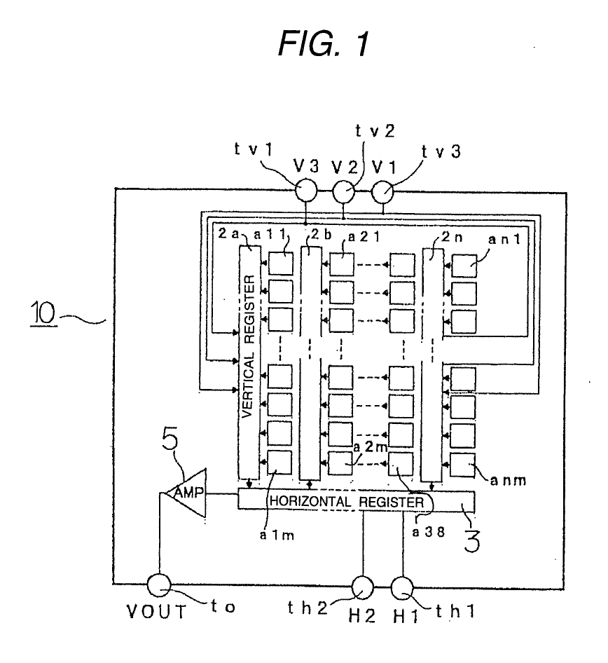

With reference to FIGS. 1-5, one embodiment of the present invention will now be explained.

FIG. 1 is an illustrative diagram showing a configuration of the embodiment of the present invention, depicting the essential elements thereof,

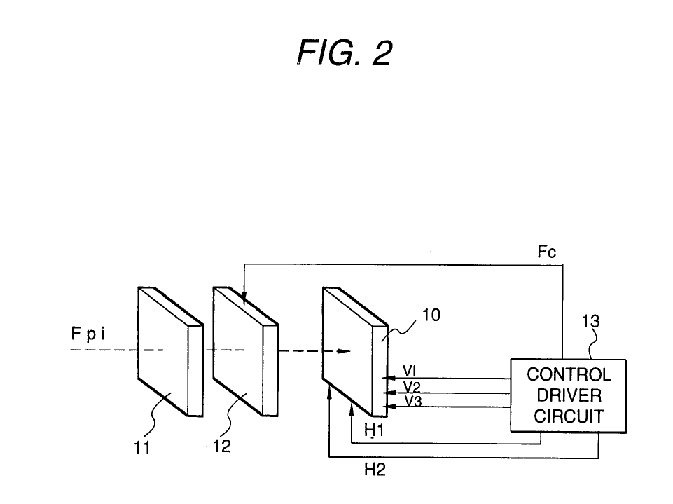

FIG. 2 is an illustrative diagram indicating an entire configuration of the embodiment of the present invention,

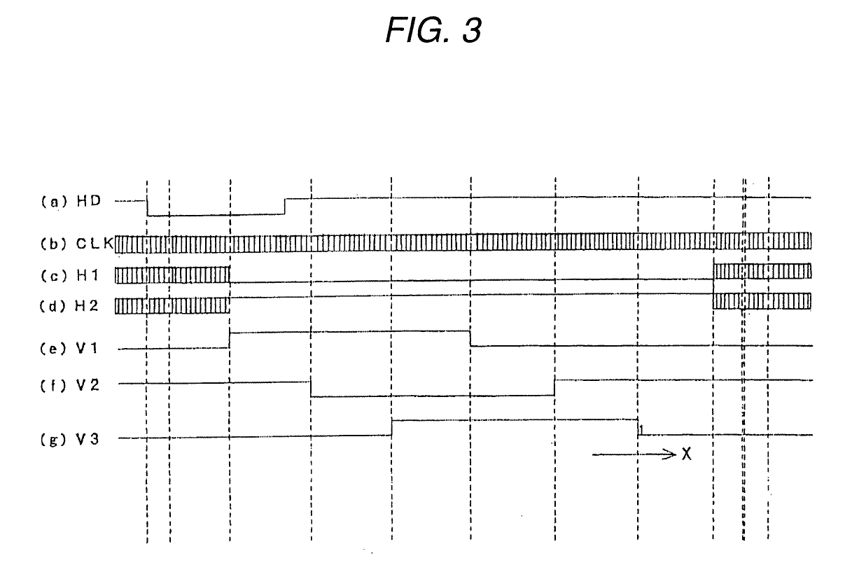

FIG. 3 is a timing chart mainly illustrating the operations performed in a pixel-readout mode of the embodiment of the present invention,

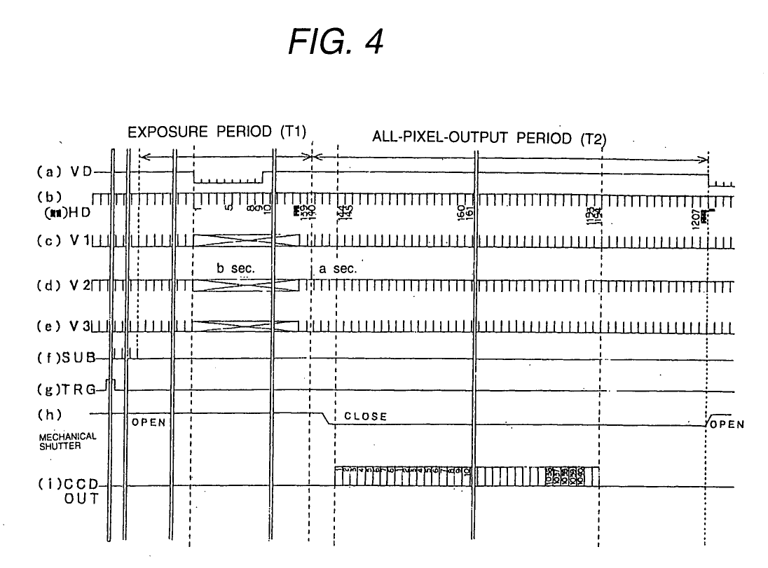

FIG. 4 is a timing chart illustrating the entire operations of the embodiment of the present invention, and

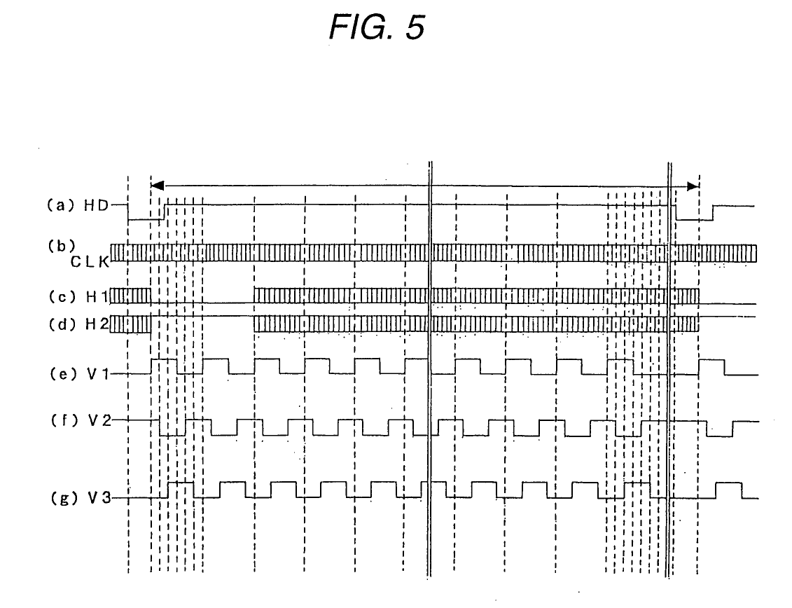

FIG. 5 is a timing chart mainly illustrating the operations performed in a smear-discharging mode of the embodiment of the present invention.

Provided within the embodiment of the present invention are, as shown in FIG. 2, a lens 11 for focusing an incident light signal Fpi from an object, a mechanical shutter 12 located at the latter stage of the lens 11 for conducting the operations of turning ON and OFF the output of the focused incident light signal Fpi, and a solid-state image sensor 10 located at the latter stage of the mechanical shutter 12 for performing photoelectric conversion of the incident light signal Fpi and outputting an image signal of the object.

In the embodiment of the present invention, a control driver circuit 13 is provided for controlling the entire operations, and the control driver circuit 13 has a function of inputting, respectively, vertical driving signals V1-V3 and horizontal driving signals H1-H2 to the solid-state image sensor 10, and a shutter driving signal Fc to the mechanical shutter 12.

In the solid-state image sensor 10 according to the embodiment of the present invention, as shown in FIG. 1 photosensors a11-anm are arranged in a matrix in the row direction (horizontal direction) and in the column direction (vertical direction), and a vertical register 2a is disposed adjacently to the photosensors a11-a1m in the first column, and a vertical register 2b is disposed adjacently to the photosensors a21-a2m in the second column, and this arrangement is repeated to a vertical register 2n disposed adjacently to the photosensors anl-anm in the n^{th} column, with each of the photosensors being connected respectively to its adjacent vertical register. These vertical registers have a function to transfer, in the vertical direction, those charges supplied by the photo registers located in their corresponding columns.

The vertical registers 2a-2n are further connected respectively to a horizontal register 3, and an output terminal of the horizontal register 3 is connected to an output terminal to of the solid-state image sensor 10 via an amplifier 5.

Although, in FIG. 1, the depiction is provided in a simplified manner so as to avoid complexity, to control terminals tv1-tv3 of the solid-state image sensor 10 to which the vertical driving signals V1-V3 are inputted from the control driver circuit 13, vertical registers 2a-2n are connected in parallel to each other, and to control terminals th1 and th2 of the solid-state image sensor 10 to which the horizontal driving signals H1 and H2 are inputted from the control driver circuit 13, the horizontal register 3 is connected.

The operation of the embodiment of the present invention in this configuration will now be explained.

In the embodiment of the present invention, the incident light signal Fpi from the object is focused by the lens 11, and introduced on to the solid-state image sensor 10 by the ON operation of the mechanical shutter 12, thereby achieving the exposure operation of the solid-state image sensor 10. As shown in FIG. 4, prior to the exposure operation for the solid-state image sensor 10, an electronic shutter signal SUB indicated by (f) in the figure is inputted into the solid-state image sensor 10, and this causes the mechanical shutter 12 to conduct the ON operation, the photosensors a11-anm to be grounded, and unnecessary charges held within the photosensors a11-anm to be discharged.

After these unnecessary charges are discharged, the exposure of the photosensors a11-anm of the solid-state image sensor 10 is performed through raster scanning according to a horizontal sync signal HD indicated by (b) in FIG. 4, and within this exposure period T1, in the region “b” of the same figure, the vertical driving signals V1, V2 and V3 are inputted from the control driver circuit 13 into the solid-state image sensor 10 as shown by (e) through (g) in FIG. 5 to cause smears within the vertical registers 2a-2n to be transferred to the horizontal register 3 at a high speed, and then the horizontal driving signals H1 and H2 indicated by (c) and (d) in FIG. 5 causes the smears to be swept out and discharged from the horizontal register 3.

When, in this way, the sweep-out operation of smears is completed in the region “b” of FIG. 4, and the exposure operation of the solid-state image sensor 10 is terminated in the region “a” of the same figure, the mechanical shutter 12 is driven into an OFF state by the shutter driving signal Fc supplied by the control driver circuit 13 so as to block the incoming external light signal directed to the solid-state image sensor 10, and as shown in FIG. 4(i), during an all-pixel-output period T2, the charges corresponding to an image signal of the object are read out from the photosensors a11-anm of the solid-state image sensor 10.

During this operation, with regard to the charges obtained through the photoelectric conversion performed within the photosensors a11-anm, first, those charges of the first field accumulated within the photosensors a11-an1, a13-an3, . . . are fed into the vertical registers 2a-2n at a given timing. The charges introduced are then transferred within the vertical registers 2a-2n in the transfer direction indicated by the arrow X in this figure by the vertical driving signals V1-V3 indicated by (e) through (g) in FIG. 3, and these charges of the first field are fed into the horizontal register 3 at a given timing.

The charges introduced into the horizontal register 3 in this manner are transferred in the horizontal direction by the horizontal driving signals H1 and H2, and read out at a given timing as an output signal.

In a similar manner, the charges of the second field accumulated within the photosensors a12-an2, a14-an4, . . . are fed into the vertical registers 2a-2n at a given timing. The charges introduced are then transferred within the vertical registers 2a-2n in the transfer direction by the vertical driving signals V1-V3, and these charges of the second field are fed into the horizontal register 3 at a given timing, and the charges introduced into the horizontal register 3 are transferred in the horizontal direction by the horizontal driving signals H1 and H2, and then read out at a given timing as an output signal.

In this way, according to the embodiment of the present invention, within the exposure period T1 during which the exposure is performed on the photosensors a11-amn, at the region “b” shown in FIG. 4, the vertical driving signals V1, V2 and V3 are inputted from the control driver circuit 13 to the solid-state image sensor 10, and by these signals V1 to V3, smears within the vertical registers 2a-2n are transferred into the horizontal register 3 at a high speed, and the smears are further swept out from the horizontal register 3 to be discharged by the horizontal driving signals H1 and H2.

When the sweep-out operation of smears is completed, and the exposure on the solid-state image sensor 10 is terminated within the region “a” shown in FIG. 4, the mechanical shutter 12, in response to the shutter driving signal Fc from the control driver circuit 13, is driven into the OFF state, and within a state where the introduction of the external light signal onto the solid-state image sensor 10 is being blocked, the charges corresponding to an image signal of the object are read out from the photosensors a11-anm of the solid-state image sensor 10 during the all-pixel-output period T2.

Therefore, with the embodiment of the present invention, a clear, and high-quality image may be obtained through the elimination of smears within the exposure period that form bright vertical streaks on the image plane, that are resulted from those charges that have been photoelectric-converted in areas other than the photosensors a11-anm and leaked into the vertical registers 2a-2n.

In a solid-state imaging device according to the invention as claimed in claim 1, a light-receiving portion, a vertical register and a horizontal register are provided, and an input light signal received by the light-receiving portion during an exposure period is photoelectric-converted, and obtained charges are read into the vertical register, transferred from the vertical register into the horizontal register and then detected as a received light signal, and while in the exposure period during which a mechanical shutter for performing operations of opening and closing the reception of the input light signal by the light-receiving portion is performing the opening operation under the control of detection control means, smears within the vertical register is transferred at a high speed by smear discharging means to be swept out and discharged in a short time via the horizontal register, and thereafter, the charges obtained through the photoelectric conversion within the light-receiving portion are transferred through the vertical register and the horizontal register and detected by light detection means as a received light signal.

After the received light signal is detected by the light detection means, the mechanical shutter is driven to perform the closing operation under the control of detection control means, thus, with the invention described in claim 1, a clear, high-quality image may be obtained through the elimination of smears within the exposure period causing vertical bright streaks over an image plane, that are resulted from those charges photoelectric-converted within areas other than the light-receiving portion, which have leaked into the vertical register.

FIG. 1 is an illustrative diagram showing a configuration of one embodiment of the present invention depicting essential elements thereof.

FIG. 2 is an illustrative diagram showing an entire configuration of the same embodiment.

FIG. 3 is an operational timing chart mainly showing the operations performed during a pixel-readout mode of the same embodiment.

FIG. 4 is a timing chart illustrating the entire operations of the same embodiment.

FIG. 5 is an operational timing chart mainly showing the operations performed during the smear-discharging mode of the same embodiment.

### EXPLANATION OF SYMBOLS

a11-anm: photosensors
2a-2d: vertical registers
3: horizontal register
5: amplifier
10: solid-state image sensor
11: lens
12: mechanical shutter
13: control driver circuit

1. A solid-state imaging device having a light-receiving portion, a vertical register and a horizontal register, wherein an input light signal received by said light-receiving portion during an exposure period is photoelectric-converted within said light-receiving portion, and obtained charges are read into said vertical register, transferred from said vertical register to said horizontal register, and then detected as a received light signal, said solid-state imaging device comprising;
a mechanical shutter performing operations of opening and closing the reception of said input light signal by said light-receiving portion;
smear discharging means for sweeping out and discharging smears in said vertical register via said horizontal register by transferring them at a high speed within said exposure period during which said mechanical shutter is performing the opening operation;
light detection means for detecting the received light signal by transferring, through said vertical register and said horizontal register, the charges obtained through the photoelectric conversion performed in said light-receiving portion and detecting them; and
detection control means for controlling the light detection in a manner that said light detection means is driven to perform the detection of the received light signal after smears are discharged by said smear discharging means, and said mechanical shutter is driven to perform the closing operation after said detection is completed.
